(19) United States
(12) Patent Application Publication
(10) Pub. No.: US 2009/0090151 A1
(43) Pub. Date: Apr. 9, 2009

(54) Key ring spreader

(76) Inventor: Margaret M. Stinson, Canton, MI (US)

Correspondence Address: Margaret M. Stinson, 3100 South Lilley Rd, Canton, MI, 48188, US

(21) Appl. No.: 12/069,972

(22) Filed: Feb. 15, 2008

Related U.S. Application Data
(60) Provisional application No. 60/997,731, filed on Oct. 5, 2007.

(51) Int. Cl. A44B 15/00; B25B 33/00

(52) U.S. Cl. 70/458

(57) ABSTRACT

A thin flat piece with two holes placed at opposite ends used to house and remove keys, open packaging, remove hooks and lures and open can tab opener key ring spreader body (1) which has ring spreader apparatus (2).

### CROSS REFERENCED TO RELATED APPLICATIONS

This application relates to and claims priority from U.S. Provisional Patent Application Ser. No. 60/997,731 filed Oct. 5, 2007, specifications in which are incorporated her in by reference.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to creating an easier way of spreading apart the two rings comprise of a key ring.

2. Background of the Invention

In the past, the end user would have to use their fingers and/or finger nails to pry apart the two rings which make up the rings of a key ring which in turn house the key and/or keys thereby securing the keys to the key ring. Now the Key Ring Spreader will alleviate the need of finger nails and or fingers to separate the two rings apart which house key and/or keys. To add, the Keying Spreader has other multiple uses. For example, it is a great device for removing fishing lures from fish. In U.S. Pat. No. 4,790,161 Dick M. Edward's concept does not have as many different multiple uses. In U.S. Pat. No. 4,790,161 Dick M. Edward's concept is more like a key ring in and it of itself. On one end of the Key ring accessory, there is a place for separating a key ring which will allow for the two rings to be separated on a key ring. In Stinson, the Key Ring Spreader is not part of a key ring but used to do just what it does, separate the two rings, allowing for a key to be housed to the key ring. Furthermore, Stinson's concept can also be used as a multiple tool because of the gauge of the material. For example, pop can top opener, medical identifier and prying device.

To add, the “Key Ring Spreader” has multi use capabilities for example it is a cutting tool with out a sharp and dangerous edge, used to open packaging, cut tape on boxes. The Key Ring Spreader is a great promotional give away for the automobile sale industry. The Key Ring Spreader is also a great inexpensive way to advertise a business. The Key Ring Spreader is small light weight and durable.

### BACKGROUND OF INVENTION—OBJECTS AND ADVANTAGES

Accordingly, besides the objects and advantages of the Key Ring Spreader described in my above patent, several objects and advantages of the present invention are:
A. There is nothing out like the Key Ring Spreader
B. There is nothing that will spread a key ring apart
C. There will be no more damage to ones finger nails or digits while housing keys
D. The frustration of prying apart key rings will subside.
E. There will be no more damages to ones finger nails or digits while prying open a can tab on a can.
F. The frustration of looking for a tool to extract a hook or lure from a fishes mouth will subside.
G. The end of searching for a sharp edge to open packaging.

### SUMMARY

In accordance with the present invention a Key Ring Spreader comprises of a hard said property cut to a specific shape, on opposite ends specific size holes will be placed through the hard said property.

In the drawings, related figures have the same number but different numeric suffixes.

### DRAWINGS—FIGURES

FIGS. 1(1) to 1(2) illustrates a top view of the Key Ring Spreader body with the ring spreading apparatus.

FIGS. 2(1) to 2(2) illustrates a side view of the Key Ring Spreader with ring spreading apparatus.

### DRAWINGS—REFERENCE NUMERALS

1 key ring spreader body
2 ring spreading apparatus

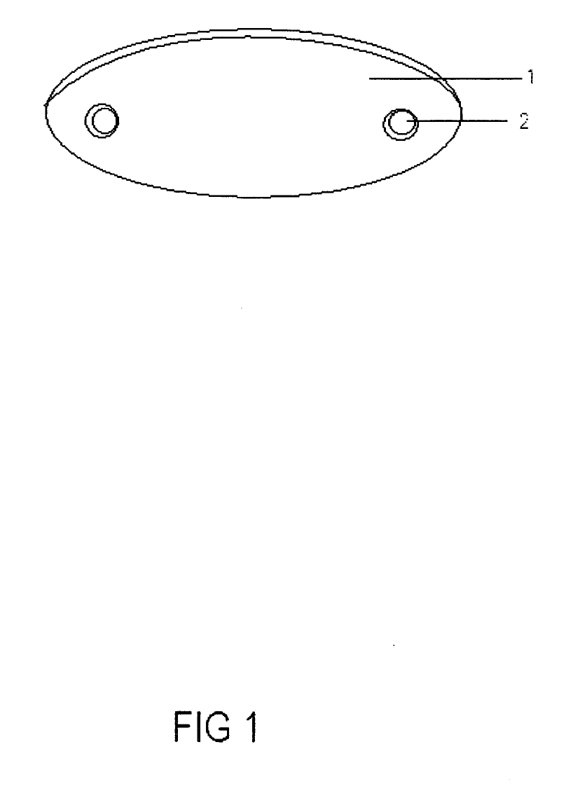

### DETAILED DESCRIPTION—FIGS. 1(1,2) and 2(1,2) PREFERRED EMBODIMENT

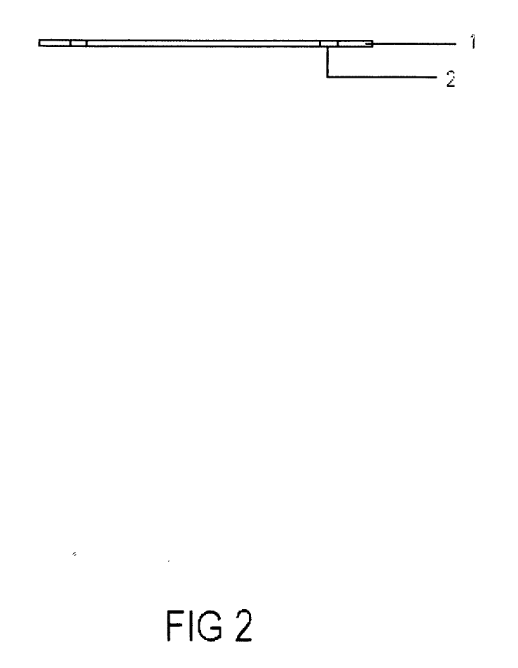

A preferred embodiment of the key ring spreader body of the present invention is illustrated in FIG. 1(1) top view. FIG. 1(2) illustrates the ring spreading apparatus top view. FIG. 2(1) illustrates the key ring spreader body, side view. FIG. 2(2) illustrates the ring spreader apparatus.

From the description above a number of advantages of my Key Ring Spreader become clear and concise
(a) Breaking finger nails while trying to house keys on a key ring will be reduced.
(b) Breaking finger nails while trying to remove keys from a key ring will be reduced.
(c) While opening packaging lacerations to the hands will be reduced
(d) Searching for a multi tool will become reduced
(e) Searching for a way to remove a hook or lure from a fish will be reduced
(f) Breaking finger nails while opening a can pop top will be reduced.

Accordingly, the reader will deduce that the key ring spreader can be used for a multi purpose tool, making it easier to house keys, open packaging with ease, remove hooks and lures and open can pop top tabs. Furthermore the reader will deduce that all of the above will reduce injury to the end user.
it allows for people to house keys with ease on a key ring
it allows for people to remove keys with ease from a key ring
it allows for people to open packaging without a sharp dangerous edge
it allows for people to remove a hook or lure from a fishes mouth with ease
it allows people to open up cans with at can top tab

Although the description above contains many specificities, These should not be construed as limiting the scope of the invention but as merely providing illustrations of some of the presently preferred embodiments of this invention

Thus the scope of the invention should be determined by the appended claims and their legal equivalents, rather than the examples given.

I claim:

1. I claim a piece of material with undetermined size holes manufactured in the gauged material.
(a) thin gauge piece of material which relates to independent claim; and
(b) thin gauge piece of material with holes manufactured in which relates to independent claim 1; and
(c) thin piece of material with slits manufactured in or not which relates to independent claim 1; and
(d) thin piece of material with gauged material able to be used as a multiple tool for example as a flathead or Phillips screwdriver which relates to independent claim 1; and
(e) thin piece of material with gauged material able to be used to remove lures from fish mouths.

2. I claim a piece of material with an elongated slit manufactured in the gauged material.
(a) thin gauge piece of material which relates to independent claim 2 and
(b) thin gauge piece of material with holes manufactured in which relates to independent claim 2 and
(c) thin piece of material with slits manufactured in or not which relates to independent claim 2 and
(d) thin piece of material with gauged material able to be used as a multiple tool for example as a flathead or Phillips screwdriver which relates to independent claim 2 and
